(19) United States
(12) Patent Application Publication
(10) Pub. No.: US 2019/0008335 A1
(43) Pub. Date: Jan. 10, 2019

(54) TOWEL DISPENSER AND AIRCRAFT WITH SUCH DISPENSER

(71) Applicant: DASSAULT AVIATION, PARIS (FR)

(72) Inventors: Denis PEUZIAT, JOUY LE MOUTIER (FR); Yann MAILLAUT, CHAMBOURCY (FR); Jean-Rémi BILLON, Paris (FR); Bruno MARCHESSOU, Neuilly sur Seine (FR)

(21) Appl. No.: 16/024,405

(22) Filed: Jun. 29, 2018

(30) Foreign Application Priority Data
Jul. 5, 2017 (FR) FR 17 00714

(51) Int. Cl. A47K 10/42; B64D 11/02

(52) U.S. Cl. CPC A47K 10/422; B64D 11/02; A47K 10/427

(57) ABSTRACT

This towel dispenser (10) comprises a housing (12) partially closed by a façade (20) defining an opening (22). The dispenser (10) further comprises a holder (30) inserted in the housing (12), this holder (30) having a substantially planar base (32) and, protruding from the base (32), at least one wall (34, 36) substantially perpendicular to the base (32). The base (32) and the or each wall (34, 36) together defining a parallelepiped cavity (38), the cavity (38) emerging outside the holder (30) through a first window arranged in a first face (56) of the parallelepiped orthogonal to the base (32) and through a second window (62) arranged in a second face (58) of the parallelepiped opposite the base (32). The holder (30) can be positioned inside the housing (12) in a first position, in which the first window faces the opening (22), and in a second position, in which the second window (62) faces the opening (22).

The present invention relates to a towel dispenser, of the type comprising a housing partially closed by a façade defining a through opening for dispensing towels.

### BACKGROUND

Such towel dispensers are known. They are generally intended for dispensing stacked disposable towels that are arranged in the housing and that can be grabbed by users through the opening arranged in the façade. These towels are generally folded such that removing a towel from the stack pulls part of the adjacent towel in the stuck with it, so as to allow one towel from the stack to extend partly through the opening at all times. Thus, users do not need to plunge their hand into the housing through the opening to grab the towels, but can grab them easily owing to the end thereof protruding from the opening.

There are two ways to stack these disposable towels. A first way is intended for transverse dispensing of the towels. In order for the towels stacked in this first way to be unfolded effectively, it is important for the pulling exerted on a towel when it is removed from the stack to be exerted in a direction substantially orthogonal to the stacking direction. A second way is intended for axial dispensing of the towels. In order for the towels stacked in this second way to be unfolded effectively, it is important for the pulling exerted on a towel when it is removed from the stack to be exerted in a direction substantially parallel to the stacking direction.

Towel dispensers are known intended to dispense towels stacked in the first manner described above. These dispensers generally have a housing suitable for the stacks of towels to be able to be arranged inside this housing such that the façade faces the edge of these stacks of towels. However, these dispensers are not suitable for dispensing towels stacked in the second manner described above.

Towel dispensers are also known intended to dispense towels stacked in the second manner described above. These dispensers generally have a housing suitable for the stacks of towels to be able to be arranged inside this housing such that the façade of the dispenser faces one end of these stacks of towels. However, these dispensers are not suitable for dispensing towels stacked in the first manner described above.

### SUMMARY OF THE INVENTION

The known dispensers are thus only compatible with one of the existing stacking methods. Yet depending on the region of the world that one is in, towels may only be available stacked according to the first or second method. This is particularly problematic when the dispenser is on board a vehicle required to travel large distances, such as an aircraft: indeed, during layovers, it is sometimes impossible to obtain towels stacked using a method compatible with the dispensing mode of the dispenser. This requires providing substantial inventories of towels on board the aircraft to avoid running out, which needlessly encumbers the aircraft. Additionally, when, despite these precautions, the excess towels are exhausted, it is necessary to buy boxes of towels during layovers that must be placed next to the dispenser, on the counter, which, in addition to being unattractive, is often cluttered.

One aim of the invention is thus to make it possible, using a single towel dispenser, to provide satisfactory dispensing of towels stacked in both the first and second manners described above.

To that end, a towel dispenser of the aforementioned type is provided, wherein the dispenser further comprises a holder inserted into the housing, the holder having a substantially planar base and, protruding from the base, at least one wall substantially perpendicular to the base, the base and the or each wall together defining a parallelepiped cavity for receiving a stack of towels, said cavity emerging outside the holder through a first window arranged in a first face of the parallelepiped substantially orthogonal to the base and through a second window arranged in a second face of the parallelepiped opposite the base, the holder being able to be positioned inside the housing in a first position, in which the first window faces the through opening, and in a second position, in which the second window faces the through opening.

According to specific embodiments of the invention, the towel dispenser also has one or more of the following features, considered alone or according to any technically possible combination(s):
the cavity contains a stack of towels, the towels of said stack being stacked in a direction substantially orthogonal to the base;
the holder comprises a plate arranged inside the cavity substantially parallel to the base and mounted movable between a retracted position close to the base and a deployed position close to the second window, the holder further comprising a device for returning the plate toward its deployed position;
the wall(s) of the holder comprise a bottom wall defining a face of the cavity opposite the first face;
the walls of the holder comprise two opposite side walls defining faces of the cavity orthogonal to the first and second faces;
each side wall has a guide cooperating with a complementary member supported by the plate to guide the plate between its retracted and deployed positions;
the holder comprises at least one rib protruding from a wall of the holder, substantially in the plane of the second face of the cavity, toward the center of the cavity;
there are at least two ribs, each protruding from a respective side wall;
the or each rib extends from an edge of the wall to the opposite edge;
the first window extends over more than 50%, in particular more than 80% and preferably substantially all of the first face;
the second window extends over more than 50%, in particular more than 70% and preferably more than 80% of the second face;
the first window and the second window communicate with one another;
the towel dispenser comprises a system for retaining the holder inside the housing in its first and second positions, said retaining system comprising a movable retaining device, secured to the holder, a first stationary retaining device, secured to the housing and suitable for cooperating with the movable retaining device so as to retain the holder in its first position, and a second stationary retaining device, secured to the housing and suitable for cooperating with the movable retaining device so as to retain the holder in its second position; and
the façade is removable.

An aircraft comprising a towel dispenser as defined above is also provided.

A method for using a towel dispenser as defined above, comprising the following successive steps:
providing a towel dispenser, the holder being positioned inside the housing in one of its first and second positions, and
moving the holder inside the housing so as to position it in the other of its first and second positions.

According to one particular embodiment of the invention, the usage method also has the following feature:
the step for moving the holder comprises a first sub-step for pivoting the holder around a first longitudinal axis and a second sub-step for pivoting the holder around a second transverse axis.

### BRIEF SUMMARY OF THE DRAWINGS

Other features and advantages of the invention will appear more clearly upon reading the following description, provided solely as an example and done in reference to the appended drawings, in which:

FIG. 1 is a three-quarters rear and top perspective view of a towel dispenser according to an embodiment of the invention, in a first configuration, a plate of said dispenser having been omitted,

FIG. 2 is a view similar to that of FIG. 1, the towel dispenser being in a second configuration and being shown in full,

FIG. 3 is a view of a detail marked III in FIG. 2,

FIG. 4 is a three-quarters front and top view of a fastener of the towel dispenser of FIG. 1, and

FIGS. 5 to 16 are three-quarters front perspective views showing the transition of the towel dispenser from the first to the second configuration.

### DETAILED DESCRIPTION

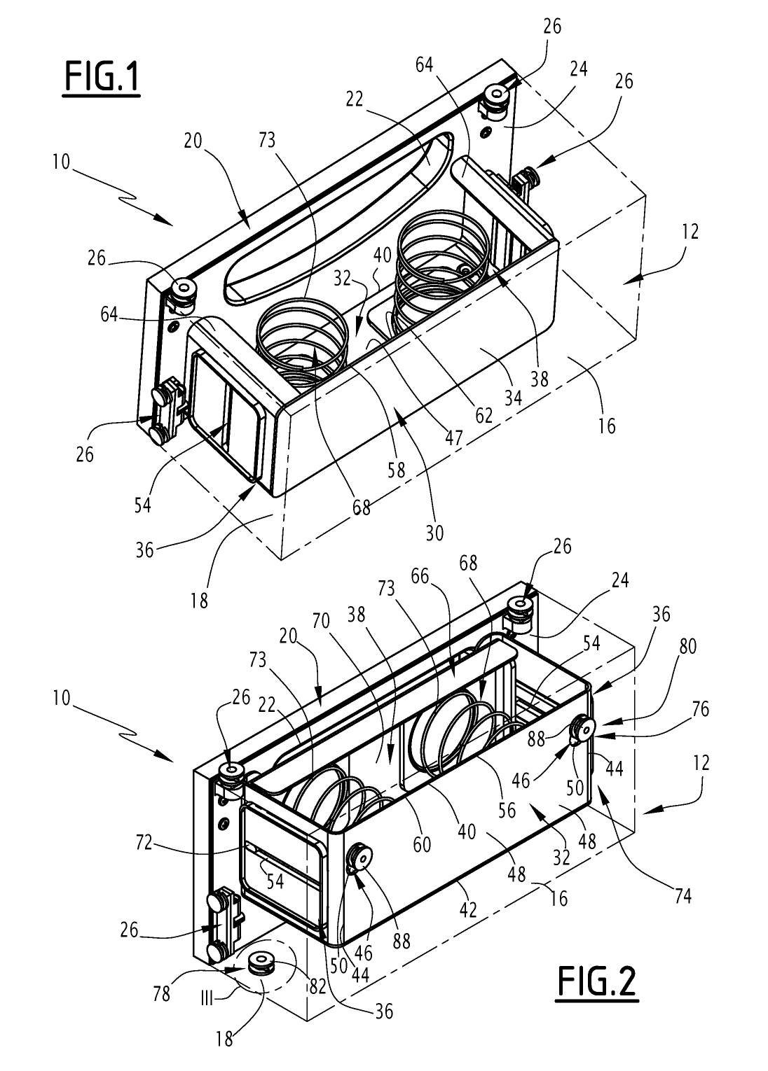

The towel dispenser 10, shown in FIGS. 1 and 2, is on board an aircraft (not shown). It is intended to dispense stacked disposable towels. To that end, the towel dispenser 10 comprises, in a known manner, a parallelepiped housing 12 suitable for receiving these disposable towels.

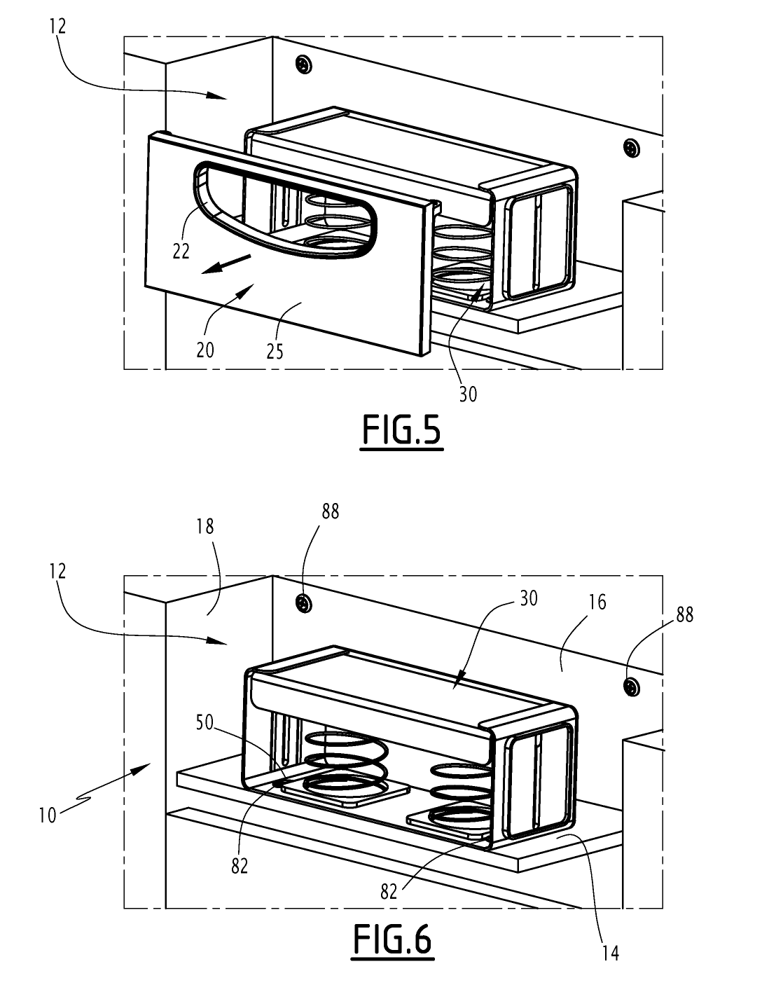

This housing 12 is delimited between a bottom wall 14 (FIG. 6), a rear wall 16 and two side walls 18. The housing 12 is also closed on its front face (opposite the rear wall 16) by a façade 20 defining a through opening 22 for dispensing towels, said through opening 22 emerging both in an inner face 24, oriented toward the housing 12, of the façade 20, and in an outer face 25 (FIG. 5), oriented opposite the housing 12, of the façade 20.

The bottom wall 14 defines an inner face, oriented toward the housing 12, which is substantially planar. Likewise, the bottom wall 16 defines an inner face, oriented toward the housing 12, which is also substantially planar.

The façade 20 is removable in the illustrated example. To that end, it comprises reversible fastening members 26 for selectively fastening the façade 20 to the housing 12 and separating the façade 20 from the housing 12.

Towel dispenser 10 also comprises a removable holder 30 able to be inserted in the housing 10 to receive the disposable towels and facilitate the dispensing of these towels through the opening 22.

The holder 30 has a substantially planar base 32 and, protruding from the base 32, three walls 34, 36 each substantially perpendicular to the base 32, the base 32 and the walls 34, 36 together defining a parallelepiped cavity 38 for receiving a stack of disposable towels.

The base 32 is substantially rectangular. It has a first transverse edge 40, a second transverse edge 42 and two side edges 44.

The base 32 also has fastening orifices 46. Each fastening orifice 46 is a through orifice and emerges both in an inner face 47 of the base 32, opening into the cavity 38, and in an outer face 48 of the base 32, oriented opposite the cavity 38.

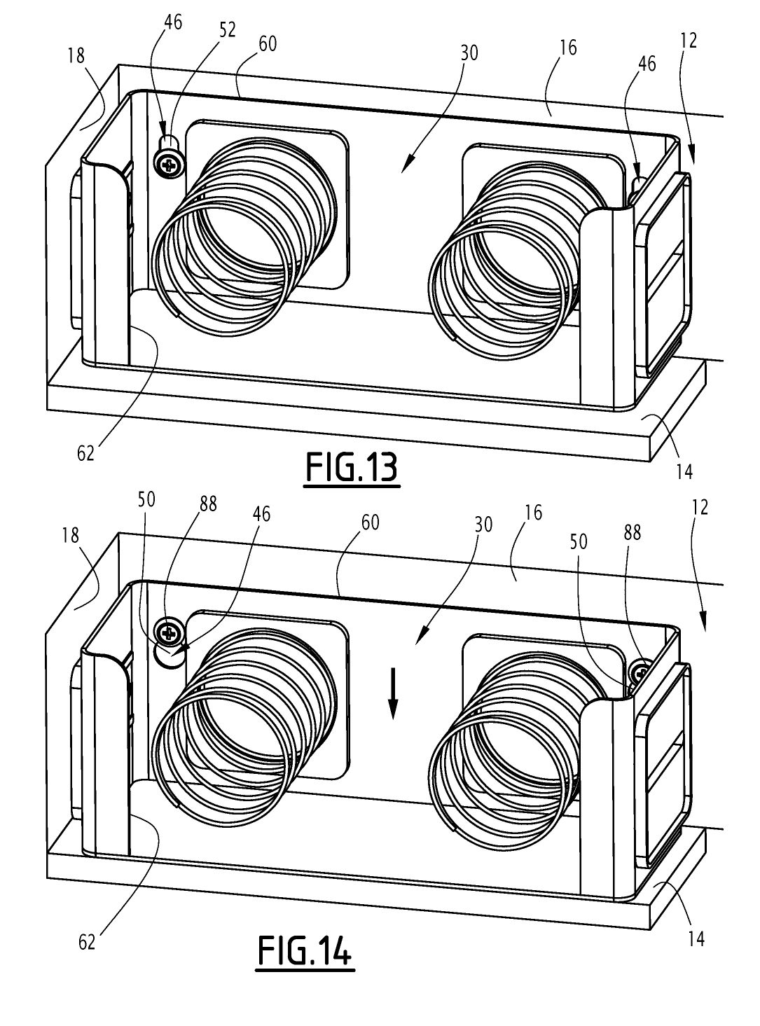

Each fastening orifice 46 in particular has a teardrop shape, with a first wide part 50, and a second narrow part 52 (FIG. 13). The narrow part 52 is closer to the first transverse edge 40 than the wide part 50.

In the illustrated example, there are two of these fastening orifices 46, each fastening orifice 46 being located in a respective corner between the first transverse edge 40 and one of the side edges 44.

The walls 34, 36 comprise a bottom wall 34 and two side walls 36. All three protrude relative to the base 32 from a respective edge 42, 44 of the base 32, substantially perpendicular to the base 32, in a same direction. In particular, the bottom wall 34 protrudes from the second edge 42 of the base 32 and each side wall 36 protrudes from a respective side edge 44 of the base 32.

The bottom wall 34 is solid. It is generally rectangular.

Each side wall 36, also substantially rectangular, has a through slit 54 emerging both in and outside the cavity 38, this slit 54 being oriented substantially perpendicular to the base 32.

The holder 30 has no wall along a first face 56 of the cavity 38, substantially orthogonal to the base 32 and the side walls 36 and opposite the bottom wall 34, and along a second face 58 of the cavity 38, substantially orthogonal to the walls 34, 36 and opposite the base 32. The cavity 38 is therefore open on said first and second faces 56, 58 and emerges outside the holder 30 through a first window 60 arranged in said first face 56 and through a second window 62 arranged in said second face 58, the first and second windows 60, 62 communicating with one another.

The first window 60 thus extends over more than 50%, in particular more than 80% and preferably, as shown, substantially all of the first face 58.

The second window 62 extends over more than 50%, in particular more than 70% and preferably, as shown, more than 80% of the first face 56. The second window 62 does not, however, extend over all of the first face 56; indeed, the holder 30 comprises two side ribs 64 each protruding from a respective side wall from among the side walls 36, substantially in the plane of the second face 58, toward the center of the cavity 38. Each side rib 64 extends from one edge of the respective side wall 36, alongside the bottom wall 34, to the opposite edge.

The distance between the side ribs 64 is smaller than the width of a standard stack of disposable towels.

The cavity 38 has dimensions suitable for receiving stacks of disposable towels. To that end, the section of the cavity 38, considered along a plane parallel to the base 32, has dimensions slightly larger than those of the cross-section of a standard stack of disposable towels. “Slightly larger” means that the difference in dimensions is smaller than 1 cm.

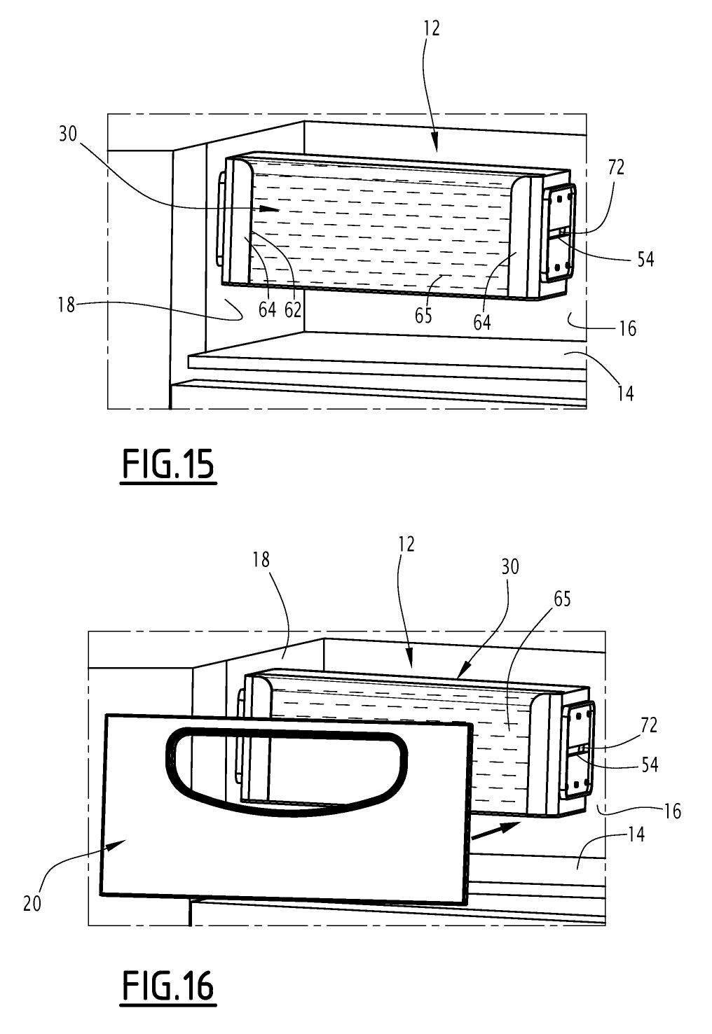

Thus, the cavity 38 is suitable for receiving stacks of disposable towels stacked in a direction substantially orthogonal to the base 32. The cavity 38 is also shown in FIGS. 15 and 16 containing a stack of towels 65 stacked in such a direction.

Returning to FIGS. 1 and 2, the holder 30 also comprises a plate 66 arranged inside the cavity 38 substantially parallel to the base 32 and mounted movable between a retracted position, close to the base 32, and a deployed position, close to the second window 62, and a device 68 for returning the plate 66 toward its deployed position.

The plate 66 comprises a substantially planar body 70 oriented parallel to the base 32. This body 70 has a shape complementary to the section of the cavity 38; thus, in the illustrated example, the body 70 has a rectangular shape and extends from one side wall 36 to the opposite side wall 36, and from the bottom wall 32 to the first face 56 of the cavity 38.

The plate 66 also comprises, at each of its side ends, a lug 72 cooperating with the slit 54 formed in a respective side wall from among the side walls 36 to guide said plate 66 between its retracted and deployed positions. The slits 54 formed in the side walls 36 and the lugs 72 of the plate 66 thus form complementary guide means for the plate 66, the slits 54 making up guides and the lugs 72 making up slides mounted moving in said guides.

The return device 68 is, in the illustrated example, formed by two compression springs 73 each inserted between the base 32 and the plate 66 while being oriented substantially perpendicular to the base 32.

The holder 30 can be positioned inside the housing 12 in a first position, shown in FIG. 1, in which the first window 60 faces the through opening 22, the second window 62 being oriented upward, and in a second position, shown in FIG. 2, in which the second window 62 faces the through opening, the first window 60 being oriented upward. Thus, the dispenser 10 allows both transverse dispensing of the towels, when the dispenser 10 is in a first configuration corresponding to the positioning of the holder 30 in its first position, and axial dispensing, when the dispenser 10 is in a second configuration corresponding to the positioning of the holder 30 in its second position.

The dispenser 10 also comprises a system 74 for retaining the holder 30 inside the housing 12 in its first and second positions.

This retaining system 74 comprises a movable retaining device 76, secured to the holder 30, a first stationary retaining device 78, secured to the housing 12, and a second stationary retaining device 80, also secured to the housing 12.

The movable retaining device 76 is made up of the fastening orifices 46 arranged in the bottom wall 32.

The first stationary retaining device 78 is suitable for cooperating with the movable retaining device 76 so as to retain the holder 30 in its first position. To that end, the first stationary retaining device 78 is formed by two primary fasteners 82 fastened to the bottom wall 14 of the housing 12.

Each primary fastener 82 is closer to the front face of the housing 12 than the rear wall 16.

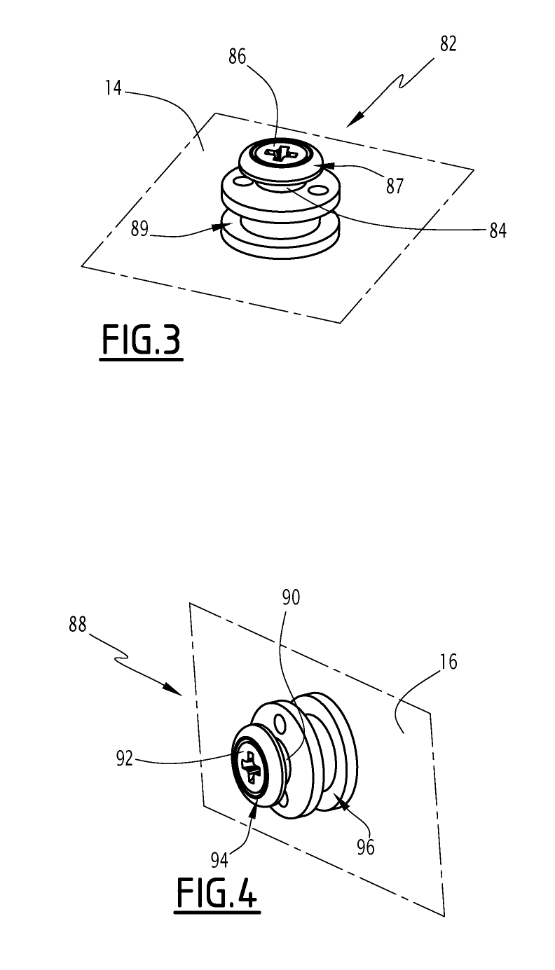

As shown in FIG. 3, each primary fastener 82 protrudes upward relative to the bottom wall 14.

Each fastener 82 is in particular formed by a rod 84 ending with a head 86 at its distal end separated from the bottom wall 14. The head 86 has a diameter, considered in a plane parallel to the bottom wall 14, smaller than the dimensions of the first wide part 50 of the fastening orifices 46 and larger than the dimensions of the second narrow part 52 of these same orifices 46. The diameter of the rod 84, still considered in a plane parallel to the bottom wall 14, is in turn smaller than the dimensions of the first wide part 50 and the second narrow part 52 of the fastening orifices 46. The rod 84 is in particular threaded and forms a screw 87 with the head 86.

Each primary fastener 82 is thus suitable for being engaged in a respective orifice from among the fastening orifices 46 and removed from this same respective orifice without disassembling any parts.

Each fastener 82 also comprises an insert 89 driven into the bottom wall 14. This insert 89 comprises a tapped orifice (not shown), complementary to the threaded rod 84 and in which said rod 84 is screwed.

When the holder 30 is in its first position, each primary fastener 82 is received in the narrow part 52 of its respective fastening orifice 46. The holder 30 is thus prevented from withdrawing by the primary fasteners 82. Furthermore, these same primary fasteners 82 prevent the holder 30 from being moved sideways or vertically.

Returning to FIGS. 1 and 2, the second stationary retaining device 80 is in turn suitable for cooperating with the movable retaining device 76 so as to retain the holder 30 in its second position. To that end, the second stationary retaining device 80 is formed by two secondary fasteners 88 fastened to the rear wall 16 of the housing 12.

As shown in FIG. 4, each secondary fastener 88 protrudes forward relative to the rear wall 16.

Each fastener 88 is in particular formed by a rod 90 ending with a head 92 at its distal end separated from the rear wall 16. The head 92 has a diameter, considered in a plane parallel to the rear wall 16, smaller than the dimensions of the first wide part 50 of the fastening orifices 46 and larger than the dimensions of the second narrow part 52 of these same orifices 46. The diameter of the rod 90, still considered in a plane parallel to the rear wall 16, is in turn smaller than the dimensions of the first wide part 50 and the second narrow part 52 of the fastening orifices 46. The rod 90 is in particular threaded and forms a screw 94 with the head 92.

Each secondary fastener 88 is thus suitable for being engaged in a respective orifice from among the fastening orifices 46 and removed from this same respective orifice without disassembling any parts.

Each fastener 88 also comprises an insert 96 driven into the bottom wall 14. This insert 96 comprises a tapped orifice (not shown), complementary to the threaded rod 90 and in which said rod 90 is screwed.

When the holder 30 is in its first position, each secondary fastener 88 is received in the narrow part 52 of its respective fastening orifice 46. The holder 30 is thus prevented from descending by the secondary fasteners 88. Furthermore, these same secondary fasteners 88 prevent the holder 30 from being moved sideways or longitudinally.

The movement of the holder 30 from its first position to its second position will now be described in reference to FIGS. 5 to 16.

Initially, the dispenser 10 is in its first configuration, the holder 30 containing disposable towels stacked in the first manner described in the preamble. When the towels in this stack have, however, been removed from the dispenser 10 and only towels stacked in the second manner described in the preamble are available for reloading, the configuration of the dispenser 10 must be changed in order to allow the axial dispensing of the towels.

To that end, the façade 20 is first removed, as shown in FIG. 5. The access to the inside of the housing 12, and more particularly to the holder 30, is then freed, as shown by FIG. 6.

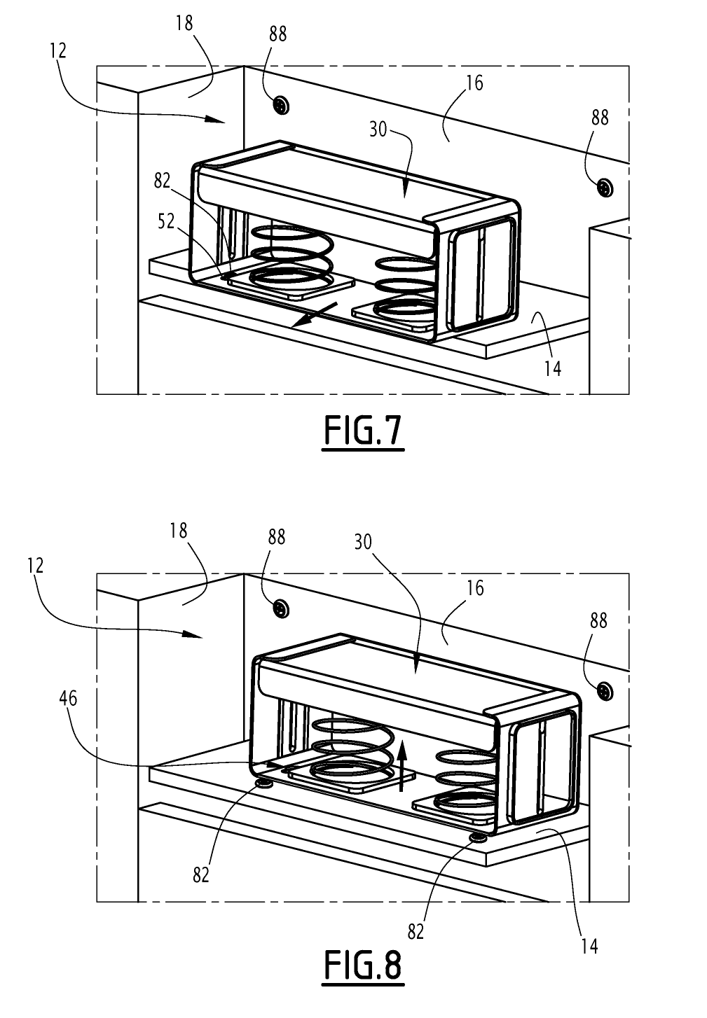

The holder 30 is then translated forward, as shown by FIG. 7. The primary fasteners 82, which were received in the narrow parts 52 of the fasting orifices 46, are then received in the wide parts 50 of these same fastening orifices 46; the primary fasteners 82 can then be disengaged from the fastening orifices 46.

This disengagement step of the primary fasteners 82 from the fastening orifices 46 immediately follows the step for translating the holder 30. To that end, the holder 30 is translated upward, as shown in FIG. 8.

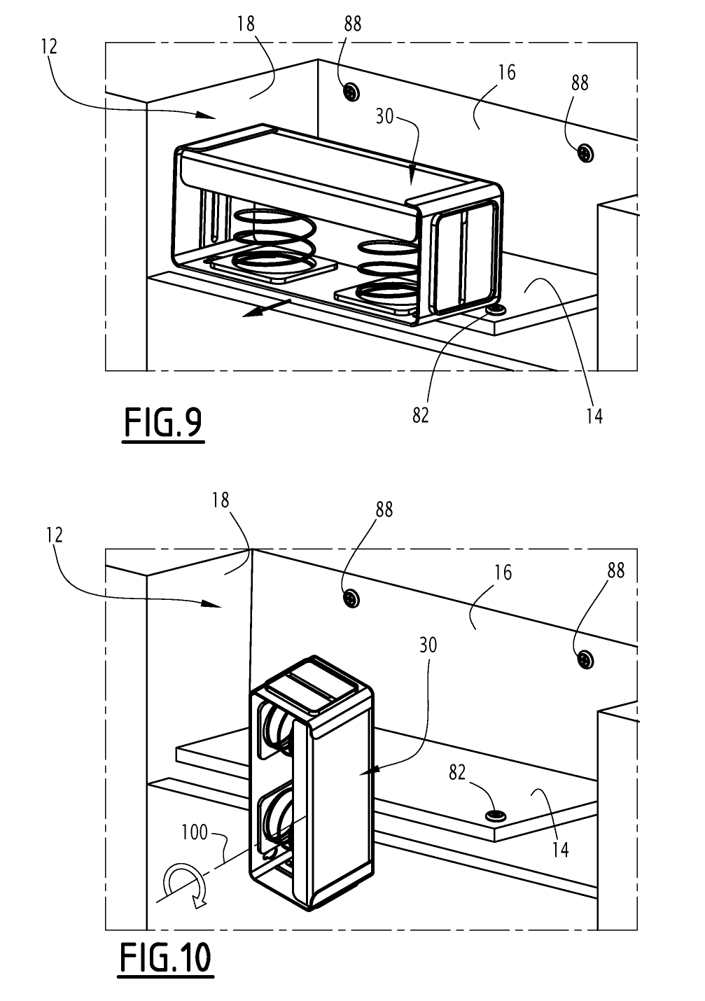

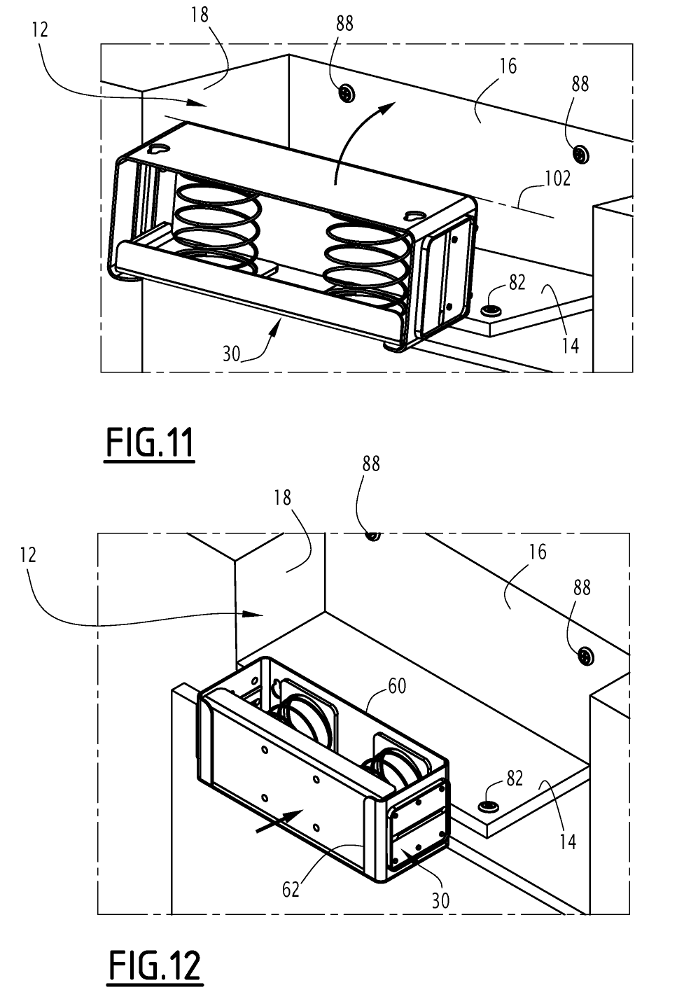

The holder 30, which then moves freely, is next removed from the housing 12 (FIG. 9), then pivoted around a first longitudinal axis 100 (FIG. 10) and a second transverse axis 102 (FIG. 11), such that the second window 62 is oriented forward and the first window 60 is oriented upward, as shown in FIG. 12.

The holder 30 is then withdrawn so as to enter the housing 12, as illustrated by FIG. 12. The holder 30 is thus withdrawn until the secondary fasteners 88 are received in the wide parts 50 of the fastening orifices 46, as shown in FIG. 13, where the plate 66 has been omitted so as to free the view of the fastening orifices 46.

The holder 30 is next lowered, as illustrated by FIG. 14, where the plate 66 has again been omitted. In so doing, the secondary fasteners 88 are moved into the narrow parts 52 of the fastening orifices 46: the holder 30 thus reaches its second position, in which it is immobilized by the secondary fasteners 88.

The holder 30 is then filled with a new stack of towels 65. To that end, the towels of the new stack 65 are inserted into the cavity 38 through the second window 62. In so doing, pressure is exerted on the plate 66, toward the base 32, so as to bring this plate 66 back to its retracted position. Once the towels are received in the cavity 38, they are pushed outside the cavity 38, toward the second window 62, by the return device 68 of the plate 66; however, the side ribs 64 retain the towels inside the cavity 38 and prevent them from leaving under the effect of this pressure alone.

The façade 20 is lastly returned to its place, as shown in FIG. 16. The housing 12 is thus closed, and the dispenser 10 is then in its second configuration, ready to allow towels to be dispensed axially.

To return the dispenser 10 to its first configuration, it suffices to carry out the aforementioned steps in the reverse order.

It is thus possible to use a single dispenser 10 to allow both an axial and transverse dispensing of towels from a stack, with an easy change of configuration between the configuration used for axial dispensing and the configuration used for transverse dispensing.

The dispenser 10 is further particularly suitable for use on board an aircraft.

Lastly, the dispenser 10 facilitates the dispensing of towels by making it possible, owing to the plate 66 and the associated return device 68, for said towels to be brought continuously closer to the dispensing opening 22.

It will be noted that the dispenser 10 may also allow use with reusable fabric towels rather than disposable towels. To that end, it in fact suffices to remove the holder 30 from the housing 12, as previously described, and to use the housing 12 to store fabric towels.

1. A towel dispenser, comprising:
a housing partially closed by a façade defining a through opening for dispensing towels; and
a holder inserted into the housing, the holder having a base which is substantially planar and, protruding from the base, at least one wall substantially perpendicular to the base, the base and the at least one wall together defining a parallelepiped cavity for receiving a stack of towels, the parallelepiped cavity emerging outside the holder through a first window arranged in a first face of the parallelepiped cavity substantially orthogonal to the base and through a second window arranged in a second face of the parallelepiped cavity opposite the base, the holder being configured to be positioned inside the housing in a first position, in which the first window faces the through opening, and in a second position, in which the second window faces the through opening.

2. The towel dispenser according to claim 1, wherein the parallelepiped cavity contains a stack of towels, the towels of the stack being stacked in a direction substantially orthogonal to the base.

3. The towel dispenser according to claim 1, wherein the holder comprises a plate arranged inside the cavity substantially parallel to the base and mounted movable between a retracted position close to the base and a deployed position close to the second window, the holder further comprising a device for returning the plate toward the deployed position.

4. The towel dispenser according to claim 3, wherein the walls of the holder comprise two opposite side walls defining faces of the cavity orthogonal to the first and second faces, each side wall having a guide cooperating with a complementary member supported by the plate to guide the plate between its retracted and deployed positions.

5. The towel dispenser according to claim 1, wherein the at least one wall of the holder comprises a bottom wall defining a face of the cavity opposite the first face.

6. The towel dispenser according to claim 1, wherein the at least one wall of the holder comprise two opposite side walls defining faces of the cavity orthogonal to the first and second faces.

7. The towel dispenser according to claim 1, wherein the holder comprises at least one rib protruding from a wall of the at least one wall the holder, substantially in the plane of the second face of the cavity, toward the center of the cavity.

8. The towel dispenser according to claim 5, wherein the holder comprises at least two ribs each protruding from a respective side wall of the holder, substantially in the plane of the second face of the cavity, toward the center of the cavity.

9. The towel dispenser according to claim 7, wherein the at least one rib extends from an edge of the wall to the opposite edge.

10. The towel dispenser according to claim 1, wherein the first window extends over more than 50% of the first face.

11. The towel dispenser according to claim 1, wherein the second window extends over more than 50% of the second face.

12. The towel dispenser according to claim 1, wherein the first window and the second window communicate with one another.

13. The towel dispenser according to claim 1, comprising a system for retaining the holder inside the housing in its first and second positions, the retaining system comprising a movable retaining device, secured to the holder, a first stationary retaining device, secured to the housing and suitable for cooperating with the movable retaining device so as to retain the holder in its first position, and a second stationary retaining device, secured to the housing and suitable for cooperating with the movable retaining device so as to retain the holder in its second position.

14. An aircraft comprising the towel dispenser according to claim 1.

15. A method for using the towel dispenser according to claim 1, comprising the following successive steps:
providing the towel dispenser, the holder being positioned inside the housing in one of its first and second positions, and
moving the holder inside the housing so as to position it in the other of its first and second positions.
